(19) United States
(12) Patent Application Publication
(10) Pub. No.: US 2026/0164159 A1
(43) Pub. Date: Jun. 11, 2026

(54) HEADSET STORING AND CHARGING ASSEMBLY

(71) Applicant: B/E Aerospace Fischer GmbH, Landshut (DE)

(72) Inventors: Marcin Adam Chodyniecki, Swidnica (PL); Piotr Krzysztof Kaliszczyk, Wroclaw (PL); Marcin Szymon Kolodziejczak, Wroclaw (PL)

(21) Appl. No.: 19/228,004

(22) Filed: Jun. 4, 2025

(30) Foreign Application Priority Data
Jun. 4, 2024 (EP) 24461580.3

(51) Int. Cl. H04R 1/1025; B60N 2/879; B64D 11/00; B64D 11/06

(52) U.S. Cl. CPC H04R 1/1025; B60N 2/879; B64D 11/0015; B64D 11/0624; B64D 11/0646; H04R 2499/13

(57) ABSTRACT

A headrest assembly comprising a seat headrest (1), a charging device (10) for charging a headset, mounted to or in the headrest, and activation means (101) for activating the charging device in response to location of a headset, in use, on the headrest, to charge the headset.

### CROSS-REFERENCE TO RELATED APPLICATIONS

The present application claims the benefit of European Patent Application No. EP24461580.3, filed Jun. 4, 2024, which is herein incorporated by reference in the entirety.

### TECHNICAL FIELD

The present disclosure relates to an assembly for storing and charging a headset used for communication between people in e.g. vehicles and aircraft, but also in other seating settings.

### BACKGROUND

In various environments where there is a need for two or more people to communicate, they may be provided with headsets having speaker parts arranged to be located in, over or adjacent the ears of the wearer and, in some cases, a microphone that is positioned close to the wearer's mouth. The use of headsets (also known as headphones) enables improved communication between multiple people especially when they are located in a high noise and/or high vibrational environment such as in a vehicle or aircraft or even in other noisy setting e.g. factories, crowded rooms, or where the distance between or relative spatial locations of the people mean that communication might be compromised if by means of simple voice communication.

An example of where headsets are useful for communication between people is in an aircraft where crew and/or passengers can communicate with each other via Headsets e.g. during take-off, flight and landing, where it might otherwise be difficult for them to hear each other.

Whilst the use of headsets in such environments greatly improves communication, the headsets themselves can create problems. Typically, headsets used in these environments are equipped with a cable via which they are plugged into a power source and via which audio signals are transmitted. In aircraft, for example, the headset may be plugged into a socket in the, or an adjacent, seat or seat arm. Such cables can add to the overall weight of the headset and can also present obstructions and inconvenience the user and others. When wearing the headset which is plugged in, the range of movement of the wearer is restricted by the cable and the cables can also get in the way of other passengers needing to move around. This can also present a safety issue if people trip over the cables or are, for example, prevented from quickly moving about the aircraft (or other space) in an emergency.

Another problem that has been identified as that, when the headsets are not in use, people do not often know where to put the headset, and often leave it on a seat, or on the floor, where it can be damaged. Furthermore, in cases where not all headsets are in use, they will be unsecured and may be damaged or cause damage or injury if they move around in e.g. turbulent conditions.

Thus, a need exists for an improved way of storing and charging headsets.

### SUMMARY

In some aspects, the techniques described herein relate to a headrest assembly including: a seat headrest, a charging device for charging a headset, wherein the charging device is mounted to or located in the headrest, and an activator configured for activating the charging device in response a headset coming into physical contact with the headrest, wherein the charging device charges the headset.

### BRIEF DESCRIPTION OF THE DRAWINGS

Examples of the assembly according to the disclosure will be described with reference to the drawings. It should be noted that these are examples only and that variations are possible within the scope of the claims.

FIG. 1 is a front view of an example of a headrest assembly according to the disclosure.

FIG. 2 is a rear view of a headrest assembly as shown in FIG. 1.

FIG. 3 shows a headrest assembly as shown in FIGS. 1 and 2, with a headset located thereon.

FIG. 4 is an exploded view of a headrest assembly according to the disclosure.

FIG. 5A shows a view of the interior of one side of a headrest assembly according to the disclosure.

FIG. 5B shows a view of the interior of another side of a headrest assembly according to the disclosure.

FIG. 6A shows, from a first perspective, details of a charging device in a headrest assembly according to the disclosure.

FIG. 6B shows the arrangement of FIG. 6A from an alternative perspective.

FIG. 7 shows an opened-out view of a headrest assembly according to the disclosure.

FIG. 8 illustrates further details of a headrest assembly according to the disclosure.

### DETAILED DESCRIPTION

The headrest assembly of this disclosure, as depicted in in the figures, has a headset charging device 10 incorporated into the headrest 1 of a seat such that when a headset 30 is located onto the headrest 1, the charging device 10 is activated to charge the headset 30. The assembly further, in embodiments, has a holder 20 for securing the headset to the headrest in the charging location.

Seats in vehicles and aircraft are typically provided with a headrest for the safety and/or comfort of people using the seats. The headrest 1 of this assembly may be of any shape, size and configuration and made of any material suitable for use as a headrest of a seat. The headrest 1 may be formed as an integral part of, or may be attached or mounted to a seat. The seat may be for example, a passenger seat in an aircraft or vehicle or a seat for any other setting e.g. a conference or meeting room, a factory, control center, classroom, or anywhere where headsets are used in a seated setting.

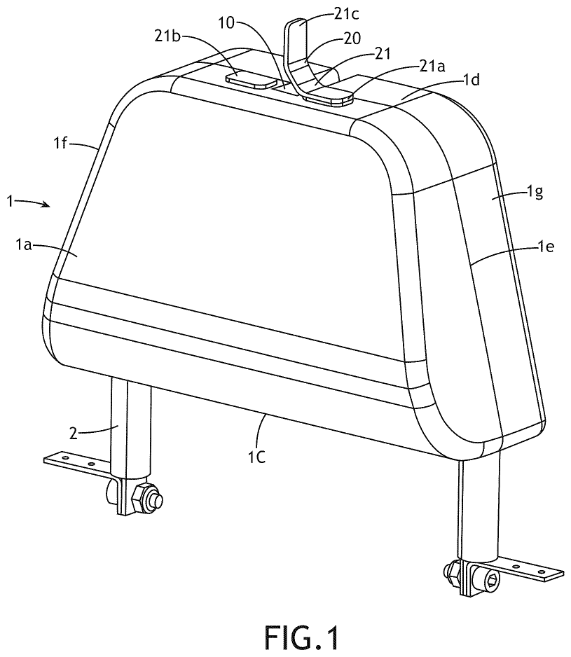

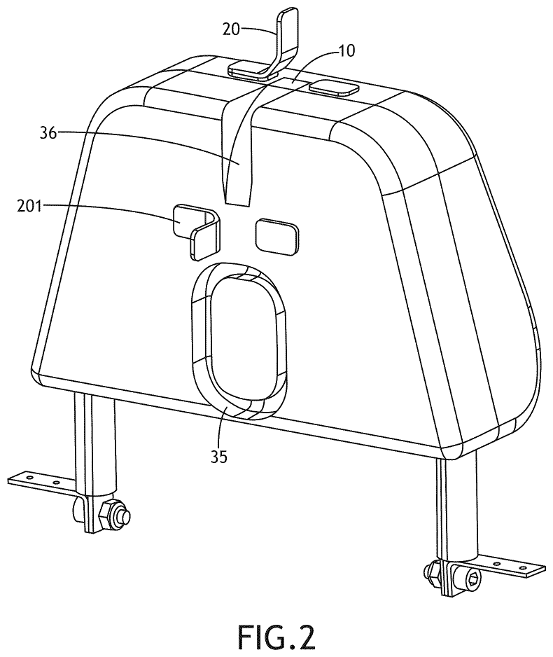

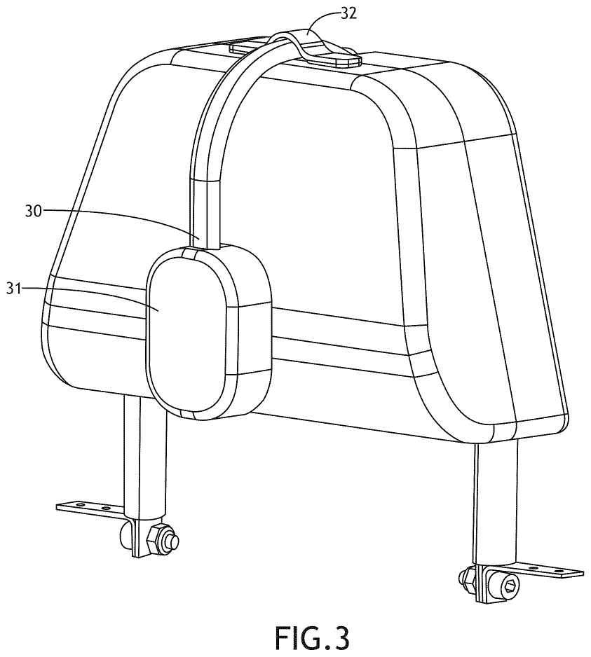

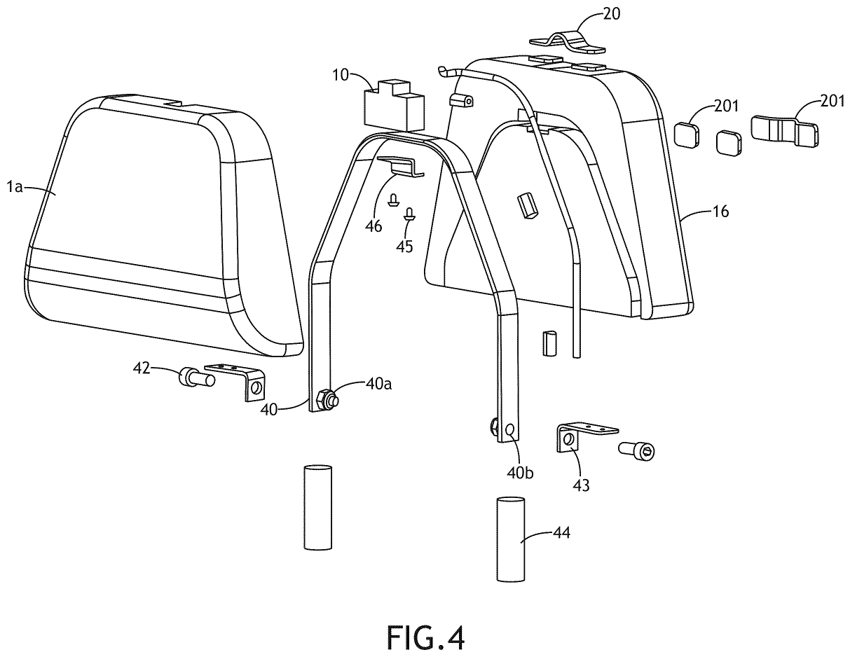

The examples described and/or shown herein are exemplary and non-limiting examples of headrests of the type of headrests that are attached by legs 2 or other attachments, to an aircraft or vehicle seat In embodiments, and as depicted in FIGS. 1-4 the headrest 1 includes a front cushion part 1a against which the user's head will rest, in use, and a rear headrest part 1b attached to the back of the front cushion part 1a. The front and rear parts 1a, 1b may combine to form the headrest 1 defined by a lower edge 1c, an upper edge 1d and side edges 1e, 1f.

The charging device 10 may also be of any known type of wireless charger suitable for charging headsets. For example, charging device 10 may be a universal charger or a charger specific to the type of headsets selected for use in the specific environment or application where the assembly of this disclosure is to be used. In examples, the charging device 10 provides inductive charging via charge coils in the charging device 10 and the headset 30. Some possible examples will be described below.

In embodiments, the charging device 10 is incorporated into the headrest 1 close to or at the upper edge 1d such that it is in proximity to the headset 30 when the headset 30 is located on the top of the headrest 1. Other locations in or on the headrest 1 are also possible, provided the charging signals reach the headset 30 when it is located on the headrest 1.

The assembly may also be provided with a holder 20 to secure the headset 30 to the headrest 1 during charging/storage of the headset 30. In the example shown, the holder 20 comprises a strap 21, which in embodiments, may be a hook and loop strap such as a Velrco® strap, secured at first end 21a to the headrest 10 and a patch 21b attached to the headrest 10 at a location spaced from the first end 21a, such that the second end 21c of the strap 21 can be fixed to the patch 21b. The location of the strap 21 is such that when the headset 30 is located on the headrest 1 in its charging location, the strap 21 secures over a part (e.g. the headband part between the ear-pieces) of the headset 30 to secure it to the headrest 1. Other holders are also envisaged such as straps secured by pins or rivets or other fixation means or various types of bracket or the like.

Regardless of the type of charger, in embodiments, the charging device 10 may only be activated when the headset 30 is located in the charging position on the headrest 1. This avoids, for example, charging radiation being emitted when a person is sitting in the seat. The assembly, therefore, includes an activator 101, such as a sensor, toggle, button, or switch, to activate the charging device 10 in response to location of the headset 30 on the headrest 1 in the charging position. The activator 101 may be, for example, a touch sensor formed on or integrated with the charging device 10 and arranged to come into physical contact with the headset 30 and to activate the charging device 10 in response to such contact. It is further envisaged that other activating methods, such as optical sensors, proximity sensors or various mechanical or electrical sensors could also be used as is other methods known in the art. In the example shown, the charging device 10 is integrated in the headrest 1 such that the activator 101 is exposed and/or protrudes from the headrest 1 (e.g., the top upper edge 1d, but could be other locations) to be contacted by the headset 30.

The assembly is configured to receive a headset 30 on the headrest 1 so that the headset 30 is in suitable contact with the charging device 10 to charge the headset 30. In the example shown, the headset 30 is of the type having two ear-pieces 31 connected or joined by a headstrap or headband 32 and the assembly is such that in the charging and storage position, the headset 30 is located with the headband 32 across the tope edge 1d of the headrest 1 and one ear-piece 31 adjacent each of the front part 1a and the rear part 1b of the headrest 1. It is also envisaged that other location orientations may be selected.

In embodiments, to facilitate, and make more visually clear and intuitive, the correct location of the headset 30 on the headrest 1 may be provided with markings or with recesses 35,36 formed in an exterior or interior surface of in the headrest 1 for one or more of the ear-pieces 31 and the headband 32 of the headset 30. The recesses 35, 36 are shaped to match the relevant part of the headset 30 for location thereof in the respective recess 35, 36. In the example shown, there may be a recess 35, 36 shaped to receive one ear-piece 31 on the front part 1a of the headrest 1, a recess 35 shaped to receive the other ear-piece 31 on the rear part 1b of the headrest 1 and a recess 36 shaped to receive the headband 32 across the top upper edge 1d of the headrest 1 from the front part 1a to the rear part 1b.

A holder 20, as discussed above, may be provided to secure over the headband 32 at the top of the headrest 1. A further holder 201 may be provided to fasten the headset 30 to the front and/or rear parts 1a, 1b of the headrest 1. In embodiments, the holders 20, 201 help prevent undesired movement of the headset 30, and may require a user action to open the holders 20, 201 to remove the headset 30 from the charging device 10 to place the headset 30 on the user's head.

As mentioned above, the charging device 10 may be attached to or integrated in the headrest 1, and various types of charging devices and headrest combinations are envisaged. In the exemplary embodiment, the charging device 10 is located between the front part 1a and the rear part 1b of the headrest 1 and is positioned such that the activator 101 is exposed and/or protrudes from the upper edge 1d of the headrest 1. To support the charging device 10 in the correct position relative to the headrest 1, the charging device 10 may be mounted to a frame 40 within the headrest 1. The frame 40 may be made, for example, of sheet metal or flat metal bars bent of formed into shape to fit within the headrest 1. In the example shown, the charging device 10 is supported on a frame 40 that forms part of an existing headrest 1 structure, and which has opposing ends 40a, 40b which form or are attached to, e.g. using screws and/or brackets 42,43 the legs 2 of the headrest 1 for attachment to the seat. Covers 44 may be provided over the exposed parts of the frame 40 for comfort/aesthetic reasons. The charging device 10 may be attached to the frame 40 by e.g. screws 45 and/or brackets 46. It should be clear that this is only one example of how a charging device 10 may be mounted within a headrest 1.

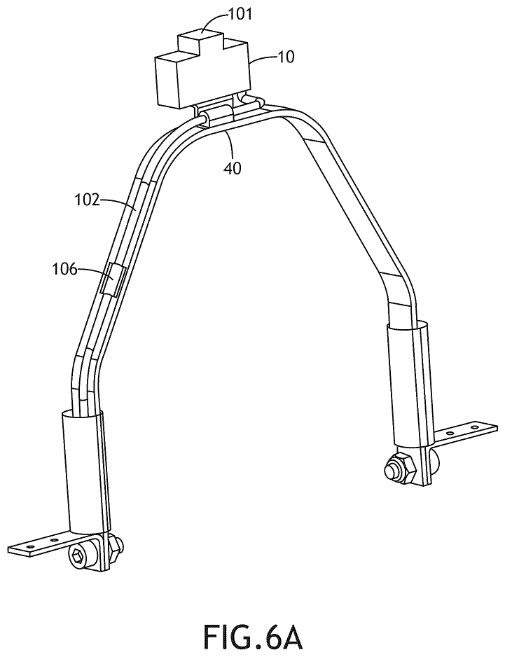

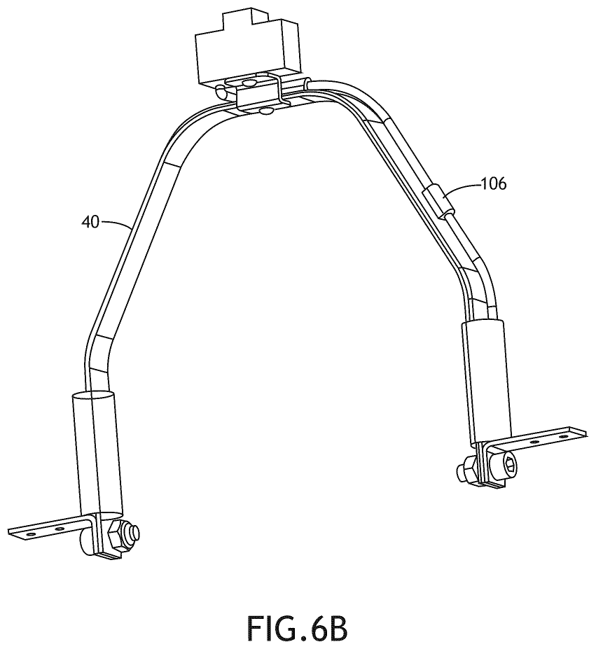

The charging device 10 may be powered by any known power source. In one example, as shown, the charging device 10 is connected to a power source via a cable 102. This cable may run from the charging device 10 within the headrest 1 and exit the headrest 1 at a bottom edge 1c to attach to a power source. As best seen in FIGS. 6A and 6B, the cable 102 can run along and be secured to the headrest frame 40 by e.g. cable holders 106. Alternatively, the power source may be e.g. a battery (which may be rechargeable) within the charging device 10 or the headrest 1.

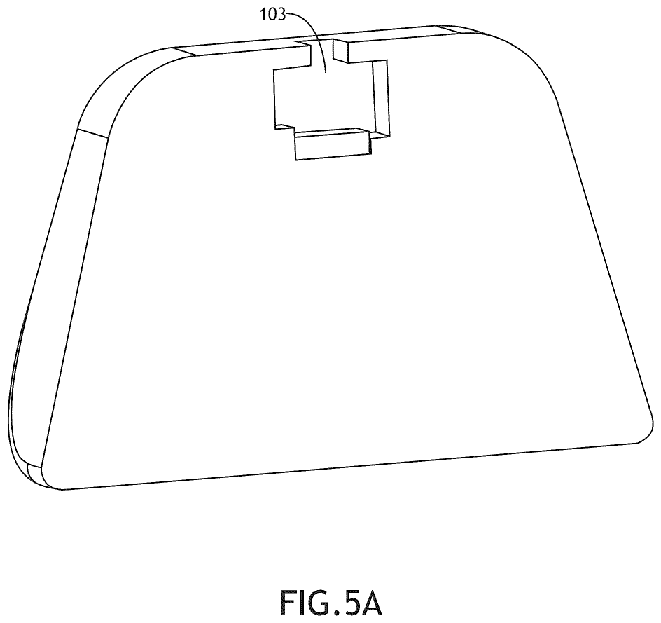

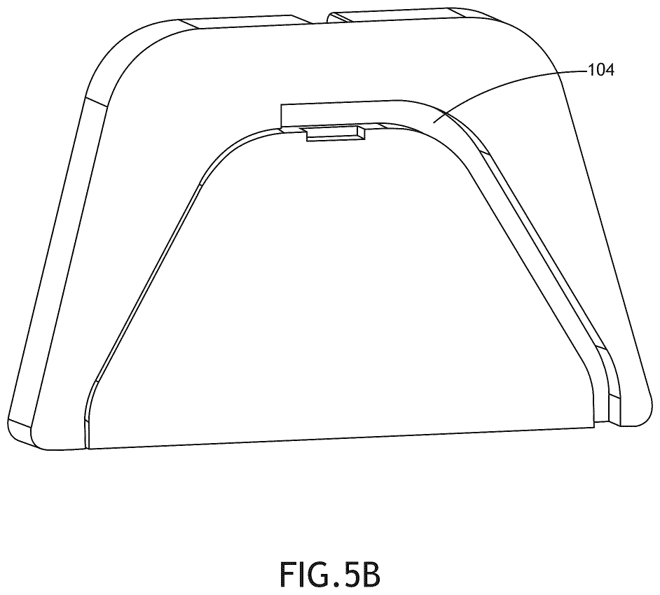

In an embodiment, and depicted in FIGS. 5A-5B, the location of the charging device 10 within the headrest 1 may vary, and for example, the charging device 10 may be held in position, by providing a recess 103 in one or both of the front 1a or rear part 1b of the headrest 1 on the inner sides (being the sides of the front 1a and rear parts 1b that come together to form the headrest 1). The recess 103 may be shaped to match the shape of the charging device 10. A recess 104 may also be provided in one or both of the headrest front 1a and rear parts 1b to accommodate the charging cable 102 if present.

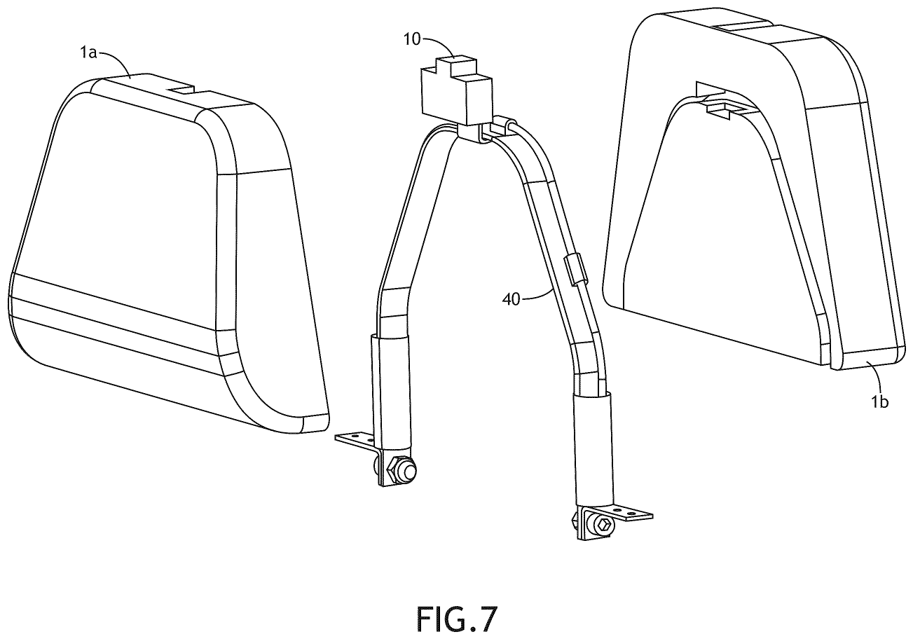

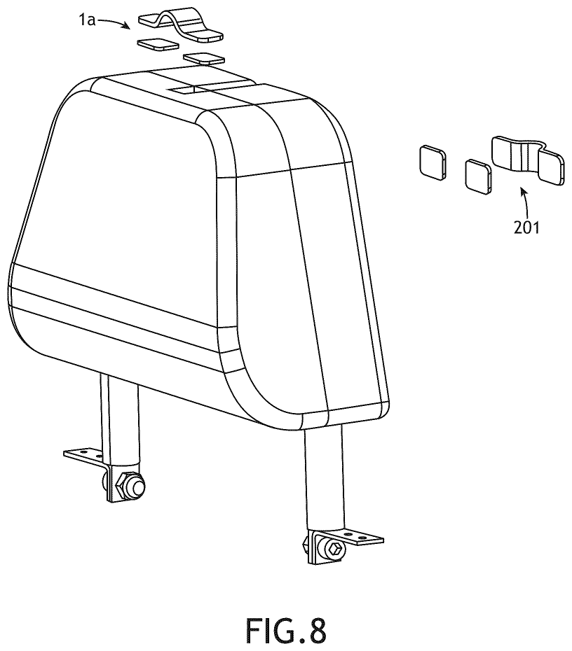

One way of assembling a headrest assembly according to the disclosure can be seen in FIGS. 7 and 8 in which the charging device 10 and cable 102 are assembled to the headrest frame 40 which is located between the front and rear parts 1a, 1b of the headrest 1. These parts are then brought together, enclosing the frame 40 and charging device 10 therebetween and are secured together e.g. by adhesion or by fasteners, to form the headrest assembly in a single headrest unit. The holders 20, 201, where present, are then applied to the exterior of the assembled headrest 1.

The headrest assembly can be designed and incorporated into the design of existing seats and provides a convenient and intuitive location for storage and charging of a headset when not in use, thus addressing the problems identified above with existing headset use. By allowing use of wireless headsets, the problems associated with cables, mentioned above, can be avoided. The assembly is simple, light and easy to use. No special tools are required to install the assembly and no additional clearance is required around the seat/headrest to accommodate the assembly.

It will be appreciated by those skilled in the art that the present disclosure has been illustrated by describing one or more specific examples thereof, but is not limited to these examples; many variations and modifications are possible within the scope of the accompanying claims.

1. A headrest assembly comprising:
a seat headrest,
a charging device for charging a headset,
wherein the charging device is mounted to or located in the headrest, and
an activator configured for activating the charging device in response a headset coming into physical contact with the headrest,
wherein the charging device charges the headset.

2. The assembly of claim 1, further comprising a holder configured to secure the headset to the headrest for charging.

3. The assembly of claim 2, wherein the holder comprises a strap arranged to be secured across the headset to the headrest.

4. The assembly of claim 3, wherein the strap is a hook and loop strap

5. The assembly of claim 1, wherein the headrest further comprises a front part and a rear part and wherein the charging device is located in the headrest between the front part and the rear part.

6. The assembly of claim 5, wherein the charging device is located adjacent a top edge of the headrest.

7. The assembly of claim 1, wherein the activator is a touch sensor arranged to be contacted by the headset when the headset is located on the headrest.

8. The assembly of claim 1, wherein the charging device is mounted on a frame within the headrest.

9. The assembly of claim 1, further comprising a cable configured for connecting the charging device to a source of power.

10. The assembly of claim 1, further comprising one or more recesses formed in an exterior surface of the headrest, the one or more recesses being shaped to receive one or more parts of the headset.

11. The assembly of claim 1, further comprising one or more recesses formed in an interior of the headrest, the one or more recesses being shaped to receive the charging device.

12. The assembly of claim 1, further comprising a headset.

13. The assembly of claim 12, wherein the headset comprises two ear-pieces joined by a headband.

14. The assembly of claim 1, wherein the headrest assembly is configured for mounting to a seat of an aircraft.
